(19) United States
(12) Patent Application Publication
(10) Pub. No.: US 2023/0160630 A1
(43) Pub. Date: May 25, 2023

(54) REFRIGERATION SYSTEM

(71) Applicant: HAMAMATSU PHOTONICS K.K., Hamamatsu-shi (JP)

(72) Inventors: Tsuyoshi KODAMA, Hamamatsu-shi (JP); Masaki YAMADA, Hamamatsu-shi (JP)

(73) Assignee: HAMAMATSU PHOTONICS K.K., Hamamatsu-shi (JP)

(21) Appl. No.: 17/985,280

(22) Filed: Nov. 11, 2022

(30) Foreign Application Priority Data
Nov. 24, 2021 (JP) 2021-189862

(51) Int. Cl. F25D 31/00; F25D 19/00; H05B 3/00

(52) U.S. Cl. CPC F25D 31/005; F25D 19/006; H05B 3/0071

(57) ABSTRACT

A refrigeration system includes: a vacuum chamber forming a cooling region accommodating an object; a cooling unit that cools the object accommodated in the cooling region; and a heating unit disposed in the cooling region to generate heat. The heating unit includes an optical fiber that guides light provided from an outside of the vacuum chamber, and a heating block that is disposed in the cooling region and that receives the light emitted from the optical fiber, to generate heat. The heating block includes a closed region configured to be isolated from the cooling region. A light-emitting end of the optical fiber is exposed to the closed region.

### TECHNICAL FIELD

The present disclosure relates to a refrigeration system.

### BACKGROUND

Japanese Unexamined Patent Publication No. 2018-151148 discloses a technique related to a cryogenic refrigeration system. The cryogenic refrigeration system includes a container that accommodates an object to be cooled. The container interferes with heat transfer from the outside. For example, the cryogenic refrigeration system disclosed in Japanese Unexamined Patent Publication No. 2018-151148 includes several radiation shields for suppressing thermal radiation.

In a refrigeration system, a container (chamber) may be opened for a variety of reasons. Immediately after a refrigerating operation is stopped, temperature of components disposed inside the chamber is low. Therefore, when the chamber is opened immediately after the refrigerating operation is stopped, there is a possibility that water vapor in the atmosphere condenses on the cooled components. As a result, frost builds up around the cooled components.

When the chamber is opened, the chamber is put on standby until the temperature of the components disposed inside the chamber reaches near-room temperature. The inside of the chamber is cooled to cryogenic temperature during refrigerating operation. Therefore, it is difficult for heat to flow into the chamber from the outside of the chamber. The components disposed inside the chamber are cooled to cryogenic temperature. Therefore, it takes a considerable time for the temperature of the components to reach near-room temperature, the components being disposed inside the chamber. As a result, a considerable time is required until the chamber is opened after the refrigerating operation is stopped.

### SUMMARY

An object of the present disclosure is to provide a refrigeration system capable of shortening the time to open a chamber.

A refrigeration system that is one aspect of the present disclosure includes: a chamber forming a cooling region which accommodates an object and in which cooling is performed; a cooling unit that cools the object accommodated in the cooling region; and a heating unit disposed in the cooling region to generate heat. The heating unit includes a heating block that is disposed in the cooling region and that receives light to generate heat, and a light irradiation unit that irradiates the heating block with the light. The heating block includes a closed region isolated from the cooling region. The light irradiation unit irradiates the closed region with the light.

The refrigeration system includes the heating block disposed inside the chamber. The heating block is irradiated with the light to generate heat. The heating block can actively raise temperature of the object disposed inside the chamber. Therefore, temperature of members disposed inside the chamber can be quickly raised. As a result, the time taken to open the chamber can be shortened.

The closed region of the refrigeration system may be isolated from the cooling region by a lid unit fixed to the heating block. The lid unit may include the light irradiation unit. According to this configuration, the closed region can be reliably isolated from the cooling region. As a result, energy of the light can be efficiently converted into thermal energy. Further, the size of the heating unit can be reduced.

The closed region of the refrigeration system may include a light absorption region to be irradiated with the light. The light absorption region may have a light absorption surface having a higher absorptance for the light than an absorptance of a base material of the heating block. According to this configuration, energy of the light can be efficiently converted into thermal energy.

The light absorption region of the refrigeration system may have a tubular shape. The light absorption surface may be an inner peripheral wall surface surrounding the light absorption region. According to this configuration, the light absorption surface is easily and efficiently irradiated with the light emitted from the light irradiation unit.

The light absorption surface of the refrigeration system may have an undulating shape. According to this configuration, a surface area of the light absorption surface is increased. As a result, energy of the light can be further efficiently converted into thermal energy.

A bottom of the light absorption region in the refrigeration system may be defined by a light absorption hole bottom surface. The light absorption hole bottom surface may have a tapered shape. According to this configuration, a traveling direction of the light can be changed. As a result, the opportunity of the light being absorbed by the light absorption surface can be increased.

The closed region of the refrigeration system may include a light-emitting end exposure region where a light-emitting end of the light irradiation unit is disposed. An area of a cross section of the light-emitting end exposure region intersecting an optical axis of the light irradiation unit may be larger than an area of a cross section intersecting an optical axis of the light absorption region. According to this configuration, the generation of return light to be incident on the light-emitting end again can be suppressed.

The light irradiation unit may further include an optical fiber that guides the light, and an optical fiber holder holding the optical fiber and attaching the optical fiber to the heating block. According to this configuration, a position of the optical fiber with respect to the heating block can be held. As a result, the heating block can be stably irradiated with the light.

A thermal conductivity of a base material of the heating block in the refrigeration system may be larger than a thermal conductivity of a base material of the optical fiber holder. According to this configuration, heat can be satisfactorily provided from the heating block to the object.

The heating block of the refrigeration system may have a first main surface and a second main surface intersecting the first main surface. The light irradiation unit may be disposed on the first main surface. The second main surface may thermally contact the object. According to this configuration, heat can be satisfactorily provided from the heating block to the object.

A heat conductive member may be sandwiched between the second main surface and the object in the refrigeration system. According to this configuration, thermal resistance between the second main surface and the object can be lowered.

The cooling unit of the refrigeration system may include a chiller and a support table that is connected to the chiller and that is disposed in the cooling region. The support table may include a stage on which the object is disposed, and a column that supports the stage. The heating unit may be attached to the column. According to this configuration, the column can be actively heated.

The cooling unit of the refrigeration system may include a chiller and a support table that is connected to the chiller and that is disposed in the cooling region. The support table may include a stage on which the object is disposed, and a column that supports the stage. The heating unit may be attached to the stage. According to this configuration, the stage can be actively heated.

The object of the refrigeration system may include an optical sensor that outputs a signal in response to incident light. According to this configuration, the refrigeration system including the optical sensor can be obtained.

### BRIEF DESCRIPTION OF THE DRAWINGS

FIG. 1 is a perspective view showing a refrigeration system of an embodiment.

FIG. 2 is a perspective view showing a heating unit included in the refrigeration system of FIG. 1.

FIG. 3 is an exploded perspective view showing an internal structure of the heating unit.

FIG. 4 is a cross-sectional view showing a closed space of the heating unit.

FIG. 5A is a cross-sectional view showing a heating unit included in a refrigeration system of Modification Example 1.

FIG. 5B is a cross-sectional view showing a heating unit included in a refrigeration system of Modification Example 2.

FIG. 6A is a cross-sectional view showing a heating unit included in a refrigeration system of Modification Example 3.

FIG. 6B is a cross-sectional view showing a heating unit included in a refrigeration system of Modification Example 4.

FIG. 7A is a side view showing disposition of a heating unit included in a refrigeration system of Modification Example 5.

FIG. 7B is a side view showing disposition of a heating unit included in a refrigeration system of Modification Example 6.

FIG. 7C is a side view showing disposition of a heating unit included in a refrigeration system of Modification Example 7.

FIG. 8A is a side view showing disposition of a heating unit included in a refrigeration system of Modification Example 8.

FIG. 8B is a side view showing disposition of a heating unit included in a refrigeration system of Modification Example 9.

FIG. 8C is a side view showing disposition of a heating unit included in a refrigeration system of Modification Example 10.

FIG. 8D is a side view showing disposition of a heating unit included in a refrigeration system of Modification Example 11.

FIG. 9A is a cross-sectional view showing a heating unit included in a refrigeration system of Modification Example 12.

FIG. 9B is a cross-sectional view showing a heating unit included in a refrigeration system of Modification Example 13.

FIG. 9C is a cross-sectional view showing a heating unit included in a refrigeration system of Modification Example 14.

FIG. 10A is a view showing disposition of a heating unit included in a refrigeration system of Modification Example 15.

FIG. 10B is a view showing disposition of a heating unit included in a refrigeration system of Modification Example 16.

FIG. 10C is a view showing disposition of a heating unit included in a refrigeration system of Modification Example 17.

FIG. 11A is a view showing disposition of a heating unit included in a refrigeration system of Modification Example 18.

FIG. 11B is a view showing disposition of a heating unit included in a refrigeration system of Modification Example 19.

FIG. 12 is a view showing a configuration in which a holding member is attached to a heating unit with a heat conductive member sandwiched therebetween.

FIG. 13A is a graph showing a result of Experimental Example 1.

FIG. 13B is a graph showing results of Experimental Example 2 and Experimental Example 3.

### DETAILED DESCRIPTION

Hereinafter, a refrigeration system of the present disclosure will be described in detail with reference to the accompanying drawings. In the description of the drawings, the same elements are denoted by the same reference signs. In the description of the drawings, duplicated descriptions will be omitted.

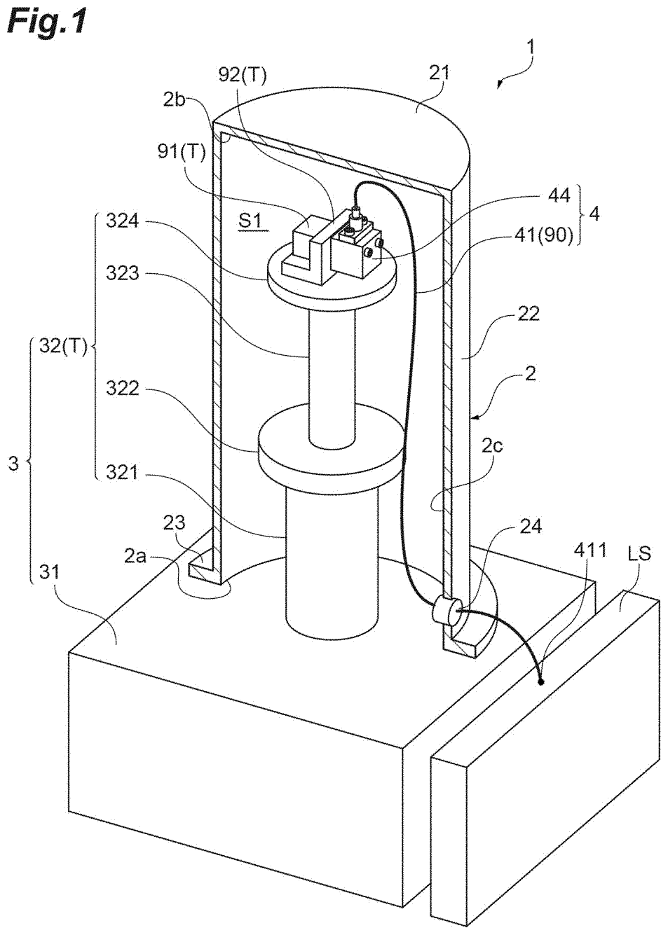

As shown in FIG. 1, a refrigeration system 1 includes a vacuum chamber 2, a cooling unit 3, and a heating unit 4. The refrigeration system 1 is a so-called cryostat. The refrigeration system 1 maintains a temperature of an object 91 at a predetermined cryogenic temperature. The object 91 is a sample for measurement, an electric drive element that operates favorably at cryogenic temperature (for example, an optical sensor), or the like.

The vacuum chamber 2 forms a cooling region S1. The cooling region S1 is a region where the object 91 is disposed. In order to maintain the temperature of the object 91 at cryogenic temperature, suppressing heat transfer to the object 91 is required. The cooling region S1 is set to vacuum to suppress heat transfer by thermal conduction to the object 91 through the air. Heat transfer to the object 91 occurs due to not only thermal conduction but also radiation. Specifically, heat from an inner wall surface of the vacuum chamber 2 is emitted as electromagnetic waves. Then, the emitted electromagnetic waves are absorbed by the object 91. When suppressing heat transfer by such radiation is also required, a heat shield that blocks heat may be provided between an inner wall of the vacuum chamber 2 and the object 91.

The vacuum chamber 2 includes a top plate portion 21, a cylindrical portion 22, and a chamber flange 23. An external shape of the vacuum chamber 2 is an approximately cylindrical shape. An upper end of the vacuum chamber 2 is closed by the top plate portion 21. A lower end of the vacuum chamber 2 is opened by an opening 2a. The vacuum chamber 2 forms a space surrounded by the top plate portion 21 and the cylindrical portion 22. The space surrounded by the top plate portion 21 and the cylindrical portion 22 is the cooling region S1. A shape of the cooling region S1 is a columnar shape. A back surface 2b of the top plate portion 21 is exposed to the cooling region S1. An inner peripheral surface 2c of the cylindrical portion 22 is also exposed to the cooling region S1. The shape of the vacuum chamber 2 is not limited to a cylindrical shape. The shape of the vacuum chamber 2 may be a rectangular cylindrical shape. The shape of the vacuum chamber 2 may be a spherical shape.

The chamber flange 23 is provided on an outer peripheral surface at the lower end of the vacuum chamber 2. The vacuum chamber 2 is fixed to the cooling unit 3 by bolts attached to the chamber flange 23. The cylindrical portion 22 of the vacuum chamber 2 is provided with a plurality of lead-out/in portions 24. The lead-out/in portion 24 is a member with a lead-out/in port that is provided from the inside to the outside of the vacuum chamber 2. It is preferable that the lead-out/in portion 24 has airtightness and heat insulation. For example, an optical fiber 41 to be described later penetrates through the lead-out/in portion 24. When the object 91 is, for example, an optical sensor, a cable for supplying electric power to the optical sensor, an optical fiber for guiding measurement light from the outside of the vacuum chamber 2 to the optical sensor, a cable for extracting a signal of the optical sensor to the outside of the vacuum chamber 2, and the like may be introduced into the vacuum chamber 2 from the lead-out/in portion 24. The function of the lead-out/in portion 24 is not limited to introducing members. The lead-out/in portion 24 may have a function of an optical connector that connects an optical fiber inside the vacuum chamber 2 and an optical fiber outside the vacuum chamber 2. The lead-out/in portion 24 may have a function of an electrical connector that connects an optical fiber inside the vacuum chamber 2 and an optical fiber outside the vacuum chamber 2. The lead-out/in portions 24 are provided in the vicinity of the lower end of the vacuum chamber 2. The lead-out/in portions 24 are provided opposite the closed top plate portion 21. In other words, the lead-out/in portions 24 are located opposite the object 91 in the space inside the vacuum chamber 2. In further other words, the lead-out/in portions 24 are provided in the vicinity of a chiller 31 to be described later. Therefore, a distance from the top plate portion 21 to the lead-out/in portions 24 approximately corresponds to a height of the vacuum chamber 2.

The cooling unit 3 includes the chiller 31 and a support table 32. The chiller 31 may be appropriately selected based on cryogenic temperature required by the refrigeration system 1 or the like. For example, a stirling chiller, a Gifford-McMahon chiller, or the like may be used as the chiller 31.

The support table 32 supports the object 91. The support table 32 functions as a heat path that transfers (conducts) heat from the object 91. An essential object to be cooled is the object 91. In the present embodiment, the object 91 is cooled by the chiller 31 through a holding member 92 to be described later and through the support table 32. Therefore, when the temperature of the object 91 is raised, the holding member 92 and the support table 32 need to be heated. Therefore, in the present embodiment, the object 91, the holding member 92, and the support table 32 are set as an object T to be heated. When the cooling unit 3 does not include the support table 32, the object T to be heated may be formed of the object 91 and the holding member 92. When the cooling unit 3 does not include the support table 32 and the holding member 92, the object T to be heated may be formed of only the object 91. Heat of the object 91 disposed on the support table 32 is transferred to the chiller 31 through the support table 32. The support table 32 is inserted from the opening 2a of the vacuum chamber 2. The support table 32 is disposed approximately coaxially with a central axis of the vacuum chamber 2. A base end of the support table 32 is disposed on a lower end side of the vacuum chamber 2. The base end of the support table 32 is thermally connected to the chiller 31. A tip of the support table 32 is disposed on a top plate portion 21 side of the vacuum chamber 2.

For example, the support table 32 includes a first column 321, a first cooling stage 322, a second column 323, and a second cooling stage 324. The configuration of the support table 32 is not limited to this configuration. The support table 32 may be formed of one column and one stage. The support table 32 may be formed of three or more columns and three or more stages. The first column 321, the first cooling stage 322, the second column 323, and the second cooling stage 324 are thermally connected to each other. An external shape of the first column 321 and of the second column 323 is, for example, a columnar shape. An external shape of the first cooling stage 322 and of the second cooling stage 324 is, for example, a disk shape. The first column 321, the first cooling stage 322, the second column 323, and the second cooling stage 324 are disposed coaxially with each other.

A base end of the first column 321 having a cylindrical shape or a columnar shape is attached to the chiller 31. A lower surface of the first cooling stage 322 is attached to a tip of the first column 321. A base end of the second column 323 is attached to an upper surface of the first cooling stage 322. A lower surface of the second cooling stage 324 is attached to a tip of the second column 323.

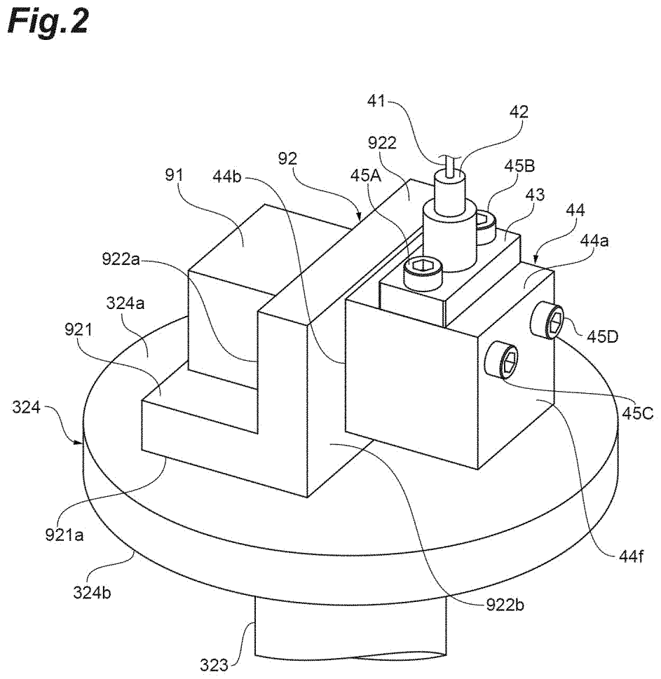

As shown in FIG. 2, the object 91 such as an optical sensor is disposed on an upper surface 324a of the second cooling stage 324. One example of the optical sensor is a semiconductor optical element that operates favorably at cryogenic temperature. Examples of the semiconductor optical element that operates favorably at cryogenic temperature include a superconducting single-photon detector (SSPD) and a superconducting nanowire single-photon detector (SNSPD). One or a plurality of cables are connected to the optical sensor. The upper surface 324a of the second cooling stage 324 is an object disposition surface on which the object 91 is disposed. For example, the holding member 92 for holding the object 91 is attached to the upper surface 324a of the second cooling stage 324. The upper surface 324a of the second cooling stage 324 contacts the holding member 92.

A cross section of the holding member 92 shown in FIG. 2 is an L shape. The holding member 92 includes a holding member base 921 and a holding member upright portion 922. A thermal conductivity of a material forming the holding member 92 is the same as a thermal conductivity of a material forming a heating block 44. The thermal conductivity of the material forming the holding member 92 is higher than the thermal conductivity of the material forming the heating block 44. The material forming the holding member 92 is, for example, copper (oxygen-free copper) or aluminum (aluminum alloy). The holding member base 921 includes a lower surface 921a. The lower surface 921a contacts the upper surface 324a of the second cooling stage 324. The object 91 is attached to one surface 922a of the holding member upright portion 922. The object 91 may be attached to an upper surface of the holding member base 921. Heat of the object 91 is transferred to the support table 32 including the second cooling stage 324, through the holding member 92.

The heating unit 4 is attached to the other surface 922b of the holding member upright portion 922. The heating unit 4 supplies heat to the object 91 and to the support table 32 through the holding member 92. The heating unit 4 supplies heat to the object T to be heated through the holding member 92.

The holding member upright portion 922 is disposed between the object 91 and the heating unit 4. The object 91 does not directly face the heating unit 4. In this specification, such disposition refers to that “the object 91 is disposed in a place where the object 91 cannot be seen from the heating unit 4”. According to this disposition, even if light L leaks from the heating unit 4, adverse effects due to the leaked light being incident on the object 91 that is, for example, an optical sensor can be suppressed. For example, the sensitivity of the optical sensor can be prevented from decreasing. The leaked light is unfavorable light. The unfavorable light is, for example, laser light that has leaked into the vacuum chamber 2 from the heating unit 4 during operation of the heating unit 4. The unfavorable light is light of an indoor lighting that intrudes into the vacuum chamber 2 through the optical fiber. Further, the unfavorable light is light that has leaked from the heating unit 4.

A shape of the holding member 92 is not particularly limited. The shape of the holding member 92 may be randomly set according to a size or shape of the object 91. The object 91 may be attached to directly contact the upper surface 324a of the second cooling stage 324 without the holding member 92 sandwiched therebetween. The heating unit 4 may be attached to directly contact the upper surface 324a of the second cooling stage 324 without the holding member 92 sandwiched therebetween. A mode of attachment of the object 91 and the heating unit 4 to the second cooling stage 324 will be described as a modification example later.

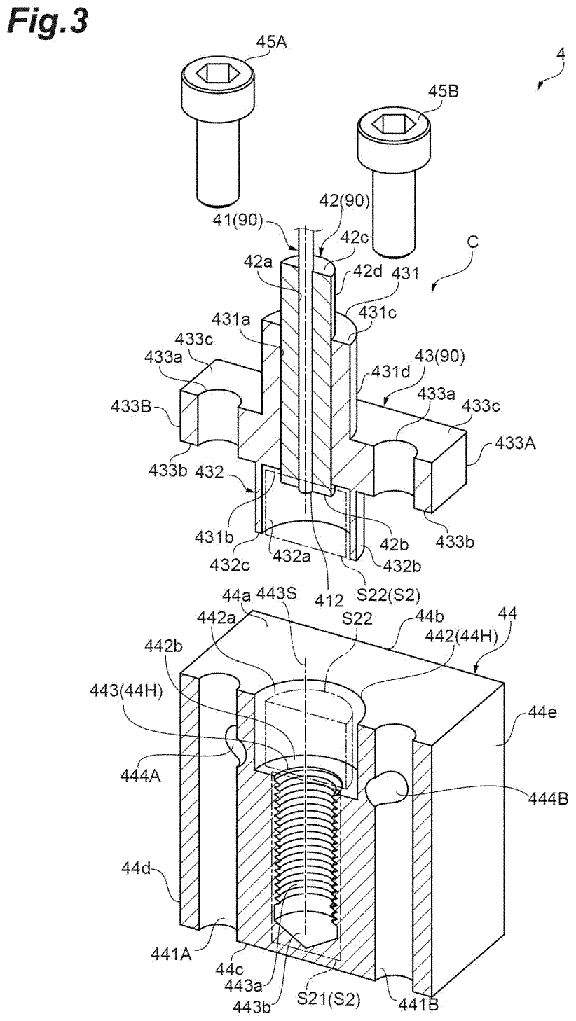

As shown in FIG. 3, the heating unit 4 includes the heating block 44 and a light irradiation unit 90. More specifically, the light irradiation unit 90 includes the optical fiber 41, a ferrule 42, and an optical fiber holder 43. The light irradiation unit 90 is fixed to the heating block 44 by joining (screwing) using a bolt 45A and a bolt 45B. The heating unit 4 is also fixed to the holding member 92 by joining (screwing) using a bolt 45C and a bolt 45D (refer to FIG. 2). In FIG. 3, an illustration of the bolt 45C and the bolt 45D is omitted.

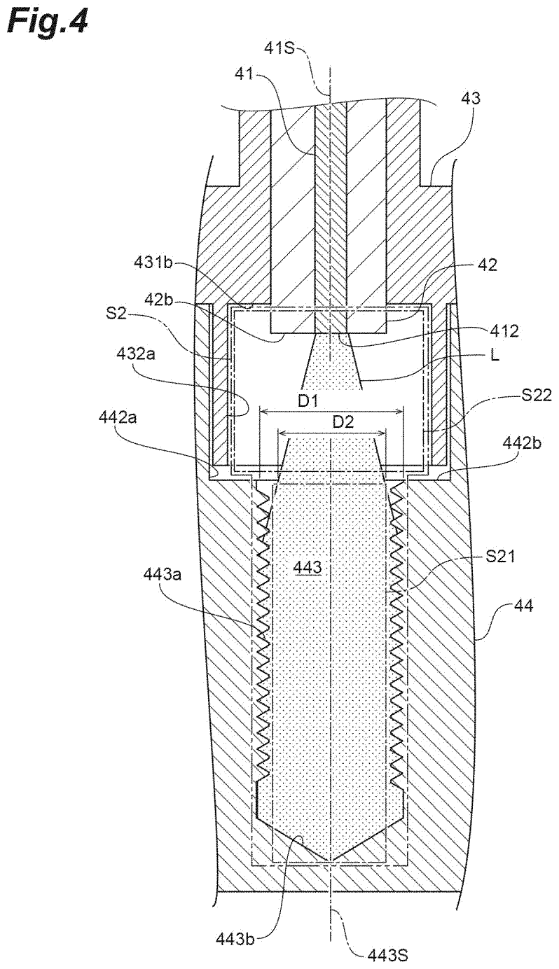

A closed region S2 formed by the heating unit 4 will be described. As shown in FIG. 4, the heating unit 4 includes the closed region S2 separated from the cooling region S1. “Being closed” means that the light L with which the closed region S2 is irradiated from the light irradiation unit 90 does not leak from the closed region S2 to the cooling region S1. In other words, the closed region S2 is a closed space. The closed region S2 is formed by closing an opening of a closed hole 44H that is a hole having a bottom surface provided in the heating block 44, with a lid unit C. In the present embodiment, a lid unit C is the light irradiation unit 90. As a result, the closed hole 44H is closed in a state where the closed hole 44H is isolated from the cooling region S1. The closed hole 44H has different inner diameters. The closed hole 44H is formed of two holes formed coaxially with each other. The two holes are a light absorption hole 443 and a fiber exposure hole 442. The light absorption hole 443 forms a light absorption region S21. The fiber exposure hole 442 forms a fiber exposure region S22 (light-emitting end exposure region). The lid unit C may be formed of a combination of the light irradiation unit 90 and another member. The lid unit C may be formed of only another member separate from the light irradiation unit 90. The closed region S2 is a region defined by the optical fiber 41, the ferrule 42, the optical fiber holder 43, and the heating block 44.

The closed region S2 includes the light absorption region S21 and the fiber exposure region S22. An inner diameter of the fiber exposure region S22 is larger than an inner diameter of the light absorption region S21. A surface defining an upper end of the fiber exposure region S22 includes an outer holder tube tip surface 431b, a ferrule tip surface 42b, and a light-emitting end 412. A surface defining a lower end of the fiber exposure region S22 includes an exposure hole bottom surface 442b. A surface defining an inner periphery of the fiber exposure region S22 includes an inner holder tube inner peripheral surface 432a and an exposure hole inner peripheral surface 442a. A surface defining a lower end of the light absorption region S21 includes a light absorption hole bottom surface 443b. A surface defining an inner periphery of the light absorption region S21 includes a light absorption surface 443a. An upper end of the light absorption region S21 is opened by an opening provided in the exposure hole bottom surface 442b.

A laser light source LS (refer to FIG. 1) is disposed outside the vacuum chamber 2. The light absorption region S21 of the heating unit 4 is irradiated with laser light output from the laser light source LS, through the light irradiation unit 90 as the light L. In the refrigeration system 1, an object to be heated is not directly irradiated with the light L for heating. A wavelength band of the laser light source LS is not particularly limited. The heating unit 4 converts energy of the light L into thermal energy. The heating unit 4 generates heat using the thermal energy. The heat is transferred to the holding member 92 through the heating unit 4.

The optical fiber 41 guides the light L from the outside of the vacuum chamber 2 to the heating unit 4. The optical fiber 41 is introduced into the vacuum chamber 2 through the lead-out/in portion 24 provided in the vacuum chamber 2. The optical fiber 41 is connected to an external device. The external device is the laser light source LS.

The optical fiber 41 is made of a glass material. When compared to a cable including a conductive member for making electrical connection, a thermal conductivity of the optical fiber 41 is lower than a thermal conductivity of the cable. For example, the cable includes a metal electrical lead, and the metal electrical lead is phosphor bronze. In this case, a thermal conductivity of the metal electrical lead is 50 W/m·K. A thermal conductivity of the optical fiber 41 made of quartz is 1.5 W/m·K. Therefore, the thermal conductivity of the optical fiber 41 made of quartz can be suppressed to approximately 1/30 of that of the cable including the metal electrical lead. As a result, thermal conduction from the outside of the vacuum chamber 2 to the inside of the vacuum chamber 2 through the optical fiber 41 made of quartz is more significantly suppressed than thermal conduction through the cable including the metal electrical lead. A significant reduction of thermal conduction greatly affects the vacuum chamber 2 that is maintained at cryogenic temperature. The optical fiber 41 includes a light-incident end 411 (refer to FIG. 1) and the light-emitting end 412. The light-incident end 411 is connected to the laser light source LS. The optical fiber 41 is formed of a plurality of optical fibers. For example, two optical fibers may be optically connected to the lead-out/in portion 24. The light-emitting end 412 is exposed to the fiber exposure region S22 to be described later.

The optical fiber 41 is physically in contact with the vacuum chamber 2 through the lead-out/in portion 24. Therefore, the optical fiber 41 can be a heat transfer path in the vacuum chamber 2. However, as described above, the thermal conductivity of the optical fiber 41 is low. Therefore, heat transmitted through the optical fiber 41 is substantially negligible. A heat quantity generated by the heating unit 4 depends on an output of the light L (laser power). Even in the case of guiding light having strong energy, outer dimensions and the like of the optical fiber 41 are not affected. A small cross-sectional area contributes to increasing thermal resistance from the viewpoint of the heat transfer path. In order to maintain the temperature of the object 91 at cryogenic temperature, it is important to reduce heat inflow from the outside of the vacuum chamber 2. Therefore, a large thermal resistance in the heat transfer path is advantageous in maintaining a cryogenic temperature state. Therefore, as a path that introduces energy for heating, the optical fiber 41 is superior to, for example, a cable for electrical connection used in a heating method using resistance heating. The optical fiber 41 has a predetermined length inside the vacuum chamber 2. The lead-out/in portion 24 into which the optical fiber 41 is introduced is disposed in the vicinity of the lower end of the vacuum chamber 2. The light-emitting end 412 of the optical fiber 41 is disposed in the heating unit 4. The heating unit 4 is disposed on the second cooling stage 324. The second cooling stage 324 is installed in the vicinity of the top plate portion 21. The optical fiber 41 has a length approximately from the lower end and the upper end of the vacuum chamber 2. A length of the optical fiber 41 also contributes to increasing thermal resistance from the viewpoint of the heat transfer path.

As shown in FIG. 3, the ferrule 42 is attached to the optical fiber 41. A shape of the ferrule 42 is a columnar shape. The ferrule 42 is made of a material having a low thermal conductivity such as zirconia. The ferrule 42 has a ferrule inner peripheral surface 42a, the ferrule tip surface 42b, a ferrule base end surface 42c, and a ferrule outer peripheral surface 42d. The ferrule inner peripheral surface 42a forms a through-hole. The ferrule inner peripheral surface 42a extends from the ferrule tip surface 42b to the ferrule base end surface 42c. The light-emitting end 412 of the optical fiber 41 is inserted into the through-hole formed by the ferrule inner peripheral surface 42a.

The ferrule base end surface 42c is exposed to the cooling region S1. The ferrule tip surface 42b is exposed to the inside of the heating unit 4 (closed region S2). In other words, the ferrule tip surface 42b is exposed to the closed region S2. For example, the ferrule tip surface 42b may be flush with the light-emitting end 412 of the optical fiber 41. The ferrule outer peripheral surface 42d is held by the optical fiber holder 43. Specifically, the ferrule 42 is inserted into the optical fiber holder 43. At least one of the ferrule tip surface 42b and the ferrule base end surface 42c is located outside the optical fiber holder 43. In the example shown in FIG. 3, both the ferrule tip surface 42b and the ferrule base end surface 42c protrude from the optical fiber holder 43.

The optical fiber holder 43 fixes the optical fiber 41 to the heating block 44. Specifically, the ferrule 42 into which the optical fiber 41 is inserted is attached to the optical fiber holder 43. The optical fiber holder 43 is fixed to the heating block 44. As a result, the optical fiber 41 is fixed to the heating block 44.

For example, metal materials are used as materials (base materials) forming the optical fiber holder 43 and the heating block 44. The metal material that is a base material of the optical fiber holder 43 has a lower thermal conductivity than that of the metal material that is a base material of the heating block 44. The metal material that is a base material of the optical fiber holder 43 is, for example, stainless steel (SUS). The metal material that is a base material of the heating block 44 is, for example, an aluminum alloy. It is difficult for heat to be transmitted from the heating block 44 to the optical fiber holder 43.

The optical fiber holder 43 includes an outer holder tube portion 431, an inner holder tube portion 432, and holder flanges 433A and 433B.

A shape of the outer holder tube portion 431 is a cylindrical shape. The outer holder tube portion 431 has an outer holder tube inner peripheral surface 431a, the outer holder tube tip surface 431b, an outer holder tube base end surface 431c, and an outer holder tube outer peripheral surface 431d. The outer holder tube inner peripheral surface 431a extends from the outer holder tube tip surface 431b to the outer holder tube base end surface 431c. The ferrule 42 is inserted into a through-hole formed by the outer holder tube inner peripheral surface 431a. The optical fiber 41, the ferrule 42, and the outer holder tube portion 431 are coaxial with each other. The outer holder tube tip surface 431b is exposed to the closed region S2. Specifically, the outer holder tube tip surface 431b is exposed to the fiber exposure region S22. An opening is formed in the outer holder tube tip surface 431b.As shown in FIG. 3, the ferrule tip surface 42b of the ferrule 42 inserted into the outer holder tube inner peripheral surface 431a may protrude from the outer holder tube tip surface 431b. The ferrule tip surface 42b may be flush with the outer holder tube tip surface 431b. The ferrule tip surface 42b may not protrude from the outer holder tube tip surface 431b. The outer holder tube base end surface 431c is exposed to the cooling region S1. As shown in FIG. 3, the ferrule base end surface 42c of the ferrule 42 inserted into the outer holder tube inner peripheral surface 431a may protrude from the outer holder tube base end surface 431c.

A shape of the inner holder tube portion 432 is a cylindrical shape. The inner holder tube portion 432 has the inner holder tube inner peripheral surface 432a, an inner holder tube outer peripheral surface 432b, and an inner holder tube tip surface 432c. The inner holder tube portion 432 protrudes from the outer holder tube tip surface 431b of the outer holder tube portion 431. A base end of the inner holder tube portion 432 is integrated with the outer holder tube portion 431. The inner holder tube portion 432 is coaxial with the outer holder tube portion 431. An inner diameter of the inner holder tube portion 432 is, as one example, the same as an outer diameter of the outer holder tube portion 431. As another example, the inner diameter of the inner holder tube portion 432 may be larger than the outer diameter of the outer holder tube portion 431. The inner diameter of the inner holder tube portion 432 is larger than an outer diameter of the ferrule 42. An outer diameter of the inner holder tube portion 432 is larger than the outer diameter of the outer holder tube portion 431. A space surrounded by the ferrule tip surface 42b, the light-emitting end 412, the inner holder tube inner peripheral surface 432a, and the outer holder tube tip surface 431b is the fiber exposure region S22. In other words, a region surrounded by the inner holder tube inner peripheral surface 432a is the fiber exposure region S22. The fiber exposure region S22 faces the inner holder tube inner peripheral surface 432a and the outer holder tube tip surface 431b.

A pair of the holder flanges 433A and 433B fix the optical fiber holder 43 to the heating block 44. The holder flanges 433A and 433B extend from the outer holder tube outer peripheral surface 431d in a radial direction of the outer holder tube portion 431. A direction in which the holder flange 433B extends is opposite a direction in which the holder flange 433A extends.

The holder flange 433A has a flange hole 433a, a flange attachment surface 433b, and a flange main surface 433c. The flange hole 433a is a through-hole. The flange hole 433a extends from the flange attachment surface 433b to the flange main surface 433c. The bolt 45B is inserted into the flange hole 433a. An inner diameter of the flange hole 433a is the same as an outer diameter of the bolt 45B. The inner diameter of the flange hole 433a is slightly larger than the outer diameter of the bolt 45B. The flange attachment surface 433b contact the heating block 44. The flange main surface 433c faces the cooling region S 1. The bolt 45B is inserted from an opening of the flange hole 433a formed in the flange main surface 433c. A head of the bolt 45B is pressed against the flange main surface 433c. A screw portion of the bolt 45B protrudes from the flange attachment surface 433b.

The holder flange 433B has the flange hole 433a, the flange attachment surface 433b, and the flange main surface 433c. The holder flange 433B extends in a direction opposite the holder flange 433A. Therefore, the outer holder tube portion 431 is located between one flange hole 433a and the other flange hole 433a. Therefore, a pair of the bolts 45A and 45B interpose the outer holder tube portion 431 therebetween. The only difference is that the holder flange 433B is provided at a position different from that of the holder flange 433A. Therefore, a detailed description regarding the holder flange 433B will be omitted.

The heating block 44 is irradiated with the light L to generate heat. The heating block 44 guides the generated heat to an object to be heated. The object to be heated is, as one example, the holding member 92. In order to satisfactorily transfer heat, the heating block 44 is made of a material having a high thermal conductivity. For example, the heating block 44 may be made of aluminum. It is desirable that heat generated in the heating block 44 is guided to the holding member 92 without loss. The loss refers to that some of heat transferred to the heating block 44 is not transferred to the holding member 92. Heat is transferred from the heating block 44 by thermal conduction and by thermal emission. Heat transfer from the heating block 44 to the holding member 92 by thermal conduction can be realized by bringing the heating block 44 into contact with the holding member 92.

Heat is released to the cooling region S1 from a portion of the heating block 44 that does not contact the holding member 92, by thermal emission (thermal radiation) as light (electromagnetic waves). This phenomenon causes energy loss. A surface of the heating block 44 that does not contact the holding member 92 may have a low emissivity. In order to reduce the emissivity, for example, the surface that does not contact the holding member 92 may be mirror-finished.

A shape of the heating block 44 is a rectangular parallelepiped shape. The shape of the heating block 44 may be a cubic shape. The shape of the heating block 44 may be a columnar shape. In the following description, it is assumed that the shape of the heating block 44 is a rectangular parallelepiped shape. The heating block 44 has a block main surface 44a (first main surface) and a block heat-outputting surface 44b (second main surface). The optical fiber holder 43 is attached to the block main surface 44a. Openings of a pair of block screw holes 441A and 441B are formed in the block main surface 44a.

Female screws are formed in the pair of respective block screw holes 441A and 441B. The screw portions of the bolts 45A and 45B are screwed to the respective female screws. The pair of block screw holes 441A and 441B may be through-holes. When the pair of block screw holes 441A and 441B are through-holes, one openings are formed in the block main surface 44a, and the other openings are formed in a block bottom surface 44c. The pair of block screw holes 441A and 441B may be blind holes having respective bottom surfaces. When the pair of block screw holes 441A and 441B are blind holes, openings are formed only in the block main surface 44a, and openings are not formed in the block bottom surface 44c. Axes of the pair of block screw holes 441A and 441B are parallel to an axis of the closed region S2. The pair of block screw holes 441A and 441B interpose the closed region S2 therebetween. More specifically, the pair of block screw holes 441A and 441B interpose the fiber exposure region S22 and the light absorption region S21 therebetween.

The pair of block screw holes 441A and 441B are cavities. Therefore, the pair of block screw holes 441A and 441B do not substantially contribute to heat transfer. There may occur a difference in thermal resistance between when the block screw hole 441A or the block screw hole 441B exists on a heat path and when the block screw hole 441A or the block screw hole 441B does not exist on the heat path. The block heat-outputting surface 44b and the pair of block screw holes 441A and 441B can also be associated with each other in terms of positional relationship. Heat is desired to be actively transferred to the block heat-outputting surface 44b. Therefore, neither of the pair of block screw holes 441A and 441B is provided between the light absorption region S21 and the block heat-outputting surface 44b. On the other hand, heat transfer to block side surfaces 44d and 44e that do not output heat is desired to be suppressed. Therefore, one block screw hole 441A may be provided between the light absorption region S21 and one block side surface 44d. The other block screw hole 441B may be provided between the light absorption region S21 and the other block side surface 44e.

An opening of the fiber exposure hole 442 is also formed in the block main surface 44a. The inner holder tube portion 432 is disposed in the fiber exposure hole 442. The fiber exposure hole 442 is for forming the fiber exposure region S22. The fiber exposure hole 442 is surrounded by the exposure hole inner peripheral surface 442a and the exposure hole bottom surface 442b. The exposure hole inner peripheral surface 442a faces the inner holder tube outer peripheral surface 432b. A slight gap may be formed between the exposure hole inner peripheral surface 442a and the inner holder tube outer peripheral surface 432b. The exposure hole bottom surface 442b faces the inner holder tube tip surface 432c. A gap is provided between the exposure hole bottom surface 442b and the inner holder tube tip surface 432c. The exposure hole bottom surface 442b does not contact the inner holder tube tip surface 432c. An opening of the light absorption region S21 is formed in the exposure hole bottom surface 442b.

The light absorption region S21 is formed on an optical axis 41S of the optical fiber 41. The light absorption region S21 is the light absorption hole 443 surrounded by the light absorption surface 443a having a circular shape in a plan view. The light absorption hole 443 is coaxial with the fiber exposure hole 442. An axis 443 S of the light absorption hole 443 and an axis of the fiber exposure hole 442 overlap the optical axis 41S of the optical fiber 41. An inner diameter of the light absorption hole 443 is smaller than an inner diameter of the fiber exposure hole 442. A difference between the inner diameter of the light absorption hole 443 and the inner diameter of the fiber exposure hole 442 appears as the exposure hole bottom surface 442b of the fiber exposure hole 442.

The light absorption surface 443a has an undulating shape to increase absorptance (emissivity) for the light L. For example, an undulating shape such as a female screw shape is formed on the light absorption surface 443a. In other words, the light absorption surface 443a is obtained by forming a spiral projection on an inner peripheral surface of the light absorption hole 443. The light absorption surface 443a is not limited to a portion on which an undulating shape is provided. For example, the light absorption surface 443a may be a portion to which surface treatment such as alumite treatment to be described later is applied. The light absorption surface 443a may be a portion having an undulating shape to which surface treatment is applied.

An undulating shape such as a female screw shape is formed from an opening of the light absorption hole 443 toward a bottom. An undulating shape such as a female screw shape may be provided on the entirety of the inner peripheral surface of the light absorption hole 443. An undulating shape such as a female screw shape may be provided on a part of the inner peripheral surface of the light absorption hole 443. In the illustrated example of FIG. 3, an undulating shape such as a female screw shape is not provided on a portion in the vicinity of the bottom surface of the light absorption hole 443.

According to the undulating shape such as a female screw shape, an area that can be irradiated with the light L can be increased. According to the undulating shape such as a female screw shape, a microscopic direction of the light absorption surface 443a is inclined with respect to the optical axis 41S of the optical fiber 41. According to this inclination, of the light L incident on the light absorption surface 443a in a direction along the optical axis 41S, the light L that is not absorbed by the light absorption surface 443a is reflected in a direction different from an incident direction. As a result, the light L is diffusely reflected, so that a so-called optical path length is lengthened. Therefore, the opportunity of the light L being incident on the light absorption surface 443a can be increased. As a result, the light L emitted from the optical fiber 41 can be satisfactorily absorbed. Since a traveling direction of the light L emitted from the optical fiber 41 is changed, the opportunity of the light being emitted from the optical fiber 41, to be incident on the optical fiber 41 again can be reduced. Therefore, return light can be reduced. As a result, damage to the optical fiber 41 due to return light being incident on the optical fiber 41 (light-emitting end 412) again can be suppressed. The undulating shape is not limited to a female screw shape. The undulating shape may be a shape of a wall-shaped portion or of a protrusion portion formed on the light absorption surface 443a.

The light absorption surface 443a is subjected to another processing of increasing an absorptance for the light L. The fact that the absorptance for the light L is high may be defined as, for example, that the absorptance of the light absorption surface 443a is higher than a reflectance. For example, the absorptance of the light absorption surface 443a may be defined as being higher than an absorptance of the base material forming the heating block 44. The processing of increasing the absorptance for light is predetermined surface treatment processing. The processing of increasing the absorptance for light is, for example, processing of making the absorptance of the base material of the heating block 44 for the light L higher than the absorptance of the light absorption surface 443a for the light L. For example, when aluminum is used as the base material of the heating block 44, the surface treatment processing is black alumite processing or plating process to increase the absorptance for light. For example, when black alumite is used, a black alumite coating that is a surface treatment layer is formed on a surface of the base material of aluminum. An absorptance of aluminum (polished surface) is 0.05. On the other hand, an absorptance of black alumite is 0.95. Therefore, the absorptance of black alumite is larger than the absorptance of aluminum. A color of the light absorption surface 443a is black. Therefore, thermal resistance between the base material of aluminum and the alumite coating is small. Heat is generated as a result of the alumite coating being irradiated with light. Heat can be satisfactorily transmitted from the alumite coating to the base material of aluminum.

The surface treatment processing is applied to at least a portion of the inner peripheral surface of the light absorption hole 443, on which an undulating shape such as a female screw shape is provided. The surface treatment processing may be applied to the entirety of the inner peripheral surface of the light absorption hole 443. The surface treatment processing may be applied to a portion on which an undulating shape such as female screw shape is not provided. The surface treatment processing may be applied to the bottom surface of the light absorption hole 443. The surface treatment processing may be applied to the exposure hole bottom surface 442b described above. The surface treatment processing may be applied to the exposure hole inner peripheral surface 442a described above. The surface treatment processing may be applied to the entirety of an inner peripheral surface of the heating block 44, which forms the closed region S2.

The bottom of the light absorption hole 443 is defined by the light absorption hole bottom surface 443b. The light absorption hole bottom surface 443b has a tapered shape that is reduced in diameter as the distance from the light-emitting end 412 of the optical fiber 41 increases. For example, the light absorption hole bottom surface 443b is an inclined surface having a conical shape. The light absorption hole bottom surface 443b is inclined with respect to the optical axis 41S of the optical fiber 41. According to such a shape, the light L incident on the light absorption hole bottom surface 443b is reflected in a direction different from an incident direction. As a result, the light L is diffusely reflected, so that the optical path length of the light L can be lengthened. As a result, the opportunity of the light L being incident on the light absorption surface 443a can be increased. Damage to the optical fiber 41 due to the light L being specularly reflected and being incident on the optical fiber 41 again can be suppressed.

A relationship between the light-emitting end 412 of the optical fiber 41, a position of the light absorption hole 443, and an inner diameter D1 of the light absorption hole 443 will be described with reference to FIG. 4. As shown in FIG. 4, the light L emitted from the light-emitting end 412 travels while spreading based on a numerical aperture (NA) of the optical fiber 41. From the point of view that heat is generated by the absorption of the light L, it is desirable that all the light L emitted from the light-emitting end 412 is guided to the light absorption hole 443. For example, it is assumed that a diameter D2 of the spread light L is larger than the inner diameter D1 of the light absorption hole 443 at the opening of the light absorption hole 443. In this case, the exposure hole bottom surface 442b is irradiated with some of the light L. On the other hand, as shown in FIG. 4, it is assumed that the diameter D2 of the spread light L is smaller than the inner diameter D1 of the light absorption hole 443 at the opening of the light absorption hole 443. In this case, all the light L is guided to the light absorption hole 443. A state of the latter can be realized by a predetermined relationship between the numerical aperture (NA) of the optical fiber 41, a distance along the optical axis 41S from the light-emitting end 412 to the opening of the light absorption hole 443, and the inner diameter of the light absorption hole 443.

As shown in FIG. 2, the block heat-outputting surface 44b is a surface that thermally contacts the holding member 92. Any object T to be heated may thermally contact the block heat-outputting surface 44b. For example, the object 91 and the second cooling stage 324 that contact the holding member 92 may thermally contact the block heat-outputting surface 44b. The block heat-outputting surface 44b is a surface different from the block main surface 44a. In the example of FIG. 2, the block heat-outputting surface 44b is orthogonal to the block main surface 44a. The block heat-outputting surface 44b may be parallel to the block main surface 44a. Namely, the block heat-outputting surface 44b may be the block bottom surface 44c to be described later.

The heating block 44 further has the block bottom surface 44c, the block side surfaces 44d and 44e, and a block back surface 44f (refer to FIG. 2). The block bottom surface 44c is parallel to the block main surface 44a. The block bottom surface 44c may be used as a heat-outputting surface. The block side surfaces 44d and 44e are orthogonal to the block heat-outputting surface 44b. The block back surface 44f faces and is parallel to the block heat-outputting surface 44b. The block side surfaces 44d and 44e and the block back surface 44f are not used as heat-outputting surfaces. Therefore, mirror finishing may be applied to the block side surfaces 44d and 44e and to the block back surface 44f to reduce emissivity. The block heat-outputting surface 44b, the block side surfaces 44d and 44e, and the block back surface 44f are four side surfaces forming the heating block 44. The block heat-outputting surface 44b, the block side surfaces 44d and 44e, and the block back surface 44f can be distinguished by block fixing holes 444A and 444B.

A pair of the block fixing holes 444A and 444B are holes into which the bolts 45C and 45D are inserted to fix the heating block 44 to the holding member 92. The pair of block fixing holes 444A and 444B are through-holes. The pair of block fixing holes 444A and 444B extend from the block back surface 44f to the block heat-outputting surface 44b. Namely, one surface in which openings of the pair of block fixing holes 444A and 444B are formed is the block heat-outputting surface 44b. The other surface in which openings of the pair of block fixing holes 444A and 444B are formed is the block back surface 44f. The openings of the pair of block fixing holes 444A and 444B are not formed in the block side surfaces 44d and 44e. The pair of block fixing holes 444A and 444B are provided to interpose the closed region S2 therebetween. More specifically, the pair of block fixing holes 444A and 444B are provided to interpose the fiber exposure region S22 therebetween.

### Operation of Refrigeration System Including Heating Unit

The refrigeration system 1 can perform, for example, the following operation. First, the chiller 31 is driven to cool the second cooling stage 324 to a predetermined temperature. The predetermined temperature is, for example, two Kelvin. Next, the chiller 31 is stopped. Next, laser light is incident from the laser light source LS. The laser light is guided to the heating unit 4 by the light irradiation unit 90, as the light L. The heating block 44 irradiated with the light L generates heat. The heat generated by the heating block 44 is transferred to the holding member 92 through the block heat-outputting surface 44b. In other words, the heat generated by the heating block 44 is transferred to the object T to be heated through the block heat-outputting surface 44b. After it is confirmed whether or not the temperature of the holding member 92 that is the object T to be heated has risen to a predetermined temperature, the emission of the light L that is laser light is stopped. The predetermined temperature is, for example, room temperature.

### Actions and Effects

The refrigeration system 1 includes the vacuum chamber 2 forming the cooling region S1 which accommodates the object 91 and in which cooling is performed; the cooling unit 3 that cools the object 91 accommodated in the cooling region S1; and the heating unit 4 disposed in the cooling region S1 to generate heat. The heating unit 4 includes the light irradiation unit 90 including the optical fiber 41 that guides light provided from the outside of the vacuum chamber 2, and the heating block 44 that is disposed in the cooling region S1 and that receives the light L emitted from the optical fiber 41, to generate heat. The heating block 44 includes the closed region S2 configured to be isolated from the cooling region S 1. The light irradiation unit 90 irradiates the closed region S2 with the light L.

The refrigeration system 1 includes the heating block 44 disposed inside the vacuum chamber 2. The heating block 44 is irradiated with the light L to generate heat. The heating block 44 can actively raise temperature of the object T to be heated disposed inside the vacuum chamber 2. Therefore, temperature of members disposed inside the vacuum chamber 2 can be quickly raised. As a result, the time taken to open the vacuum chamber 2 can be shortened.

The refrigeration system 1 can increase temperature rising rate inside the vacuum chamber 2 when maintenance of the refrigeration system 1 is performed. Further, an object disposed inside the vacuum chamber 2 may absorb gas. The absorbed gas can be quickly gasified by the heating of the heating unit 4. A heat quantity flowing into the vacuum chamber 2 due to thermal conduction can be reduced by employing the optical fiber 41. As a result, the number of cables for electrical connection provided inside the vacuum chamber 2 can also be increased. Moreover, the refrigeration system 1 can also perform cooling performance evaluation of the chiller 31. In Experimental Example 1 to be described later, the cooling performance evaluation will be described.

The closed region S2 of the refrigeration system 1 is isolated from the cooling region S1 by the lid unit C fixed to the heating block 44. The lid unit C includes the light irradiation unit 90. According to this configuration, the closed region S2 can be reliably isolated from the cooling region S1 by the lid unit C. As a result, energy of the light can be efficiently converted into thermal energy. Further, the light irradiation unit 90 can serve as at least a part of the lid unit C. As a result, the size of the heating unit 4 can be reduced.

The closed region S2 of the refrigeration system 1 includes the light absorption region S21 with which the light L is irradiated. The light absorption region S21 has the light absorption surface 443a having a higher absorptance for the light L than that of the base material of the heating block 44. According to this configuration, energy of the light L can be efficiently converted into thermal energy.

The light absorption region S21 of the refrigeration system 1 has a tubular shape. The light absorption surface 443a is an inner peripheral wall surface surrounding the light absorption region S21. According to this configuration, the light absorption surface 443a is easily and efficiently irradiated with the light L emitted from the optical fiber 41.

The light absorption surface 443a of the refrigeration system 1 has an undulating shape. According to this configuration, a surface area of the light absorption surface 443a is increased. As a result, energy of the light L can be more efficiently converted into thermal energy.

A bottom of the light absorption region S21 in the refrigeration system 1 is defined by the light absorption hole bottom surface 443b. The light absorption hole bottom surface 443b has a tapered shape. According to this configuration, the traveling direction of the light L is changed. As a result, the opportunity of light being absorbed by the light absorption surface 443a can be increased.

The absorptance of the light absorption surface 443a for the light L is larger than the reflectance of the light absorption surface 443a for the light L. According to this configuration, energy of the light L can be further efficiently converted into thermal energy.

The closed region S2 of the refrigeration system 1 includes the fiber exposure region S22 in which the light-emitting end 412 of the optical fiber 41 is disposed. An area of a cross of the fiber exposure region S22 intersecting the optical axis 41S of the optical fiber 41 is larger than an area of a cross intersecting an optical axis of the light absorption region S21. According to this configuration, the generation of return light to be incident on the optical fiber 41 again can be suppressed.

The light irradiation unit 90 further includes the optical fiber 41 that guides the light L, and the optical fiber holder 43 that holds the optical fiber 41 and that attaches the optical fiber 41 to the heating block 44. According to this configuration, a position of the optical fiber 41 with respect to the heating block 44 can be held. As a result, the heating block 44 can be stably irradiated with light.

The thermal conductivity of the base material of the heating block in the refrigeration system 1 is larger than the thermal conductivity of the base material of the optical fiber holder 43. According to this configuration, heat can be satisfactorily provided to the object 91.

The heating block 44 of the refrigeration system 1 has the block main surface 44a and the block heat-outputting surface 44b. The light irradiation unit 90 is disposed on the block main surface 44a. The block heat-outputting surface 44b thermally contacts the holding member 92 to which the object 91 is attached. According to this configuration, heat can be satisfactorily provided from the heating block 44 to the object 91 through the holding member 92.

The object 91 of the refrigeration system 1 includes an optical sensor that outputs a signal in response to incident light. According to this configuration, the refrigeration system 1 including the optical sensor can be obtained.

The refrigeration system 1 of the present disclosure is not limited to the above embodiment.

Modification Examples 1 to 4 illustrate several structures in which the optical fiber 41 is attached to the heating block 44.

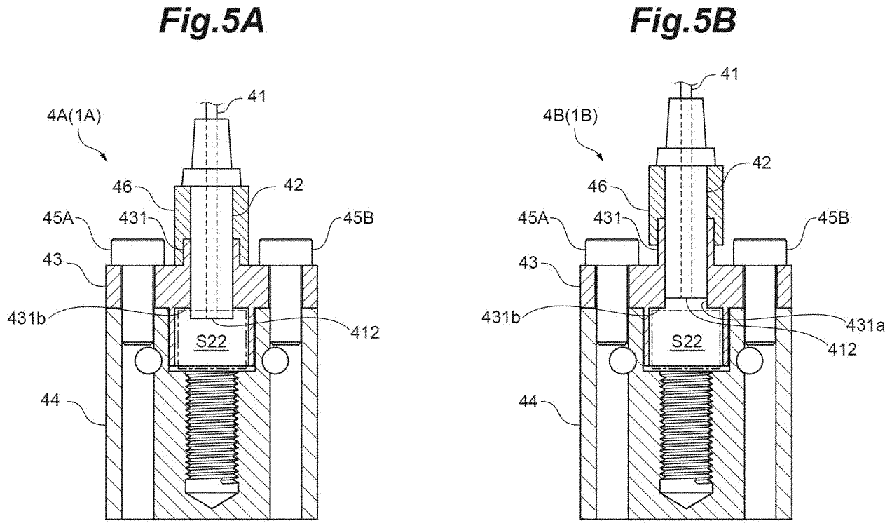

FIG. 5A shows a heating unit 4A included in a refrigeration system 1A of Modification Example 1. The heating unit 4A includes the ferrule 42, the optical fiber holder 43, the heating block 44, and an optical fiber connector 46. The heating unit 4A of Modification Example 1 is different from the heating unit 4 of the embodiment in that the heating unit 4A includes the optical fiber connector 46. The optical fiber connector 46 holds a light-emitting end 412 side of the optical fiber 41. The optical fiber connector 46 is inserted into the outer holder tube portion 431 of the optical fiber holder 43. The optical fiber holder 43 is fixed to the heating block 44 using fastening members such as the bolts 45A and 45B.

FIG. 5B shows a heating unit 4B included in a refrigeration system 1B of Modification Example 2. The heating unit 4B of Modification Example 2 is the same as the heating unit 4A of Modification Example 1 in terms of components. The heating unit 4B includes the ferrule 42, the optical fiber holder 43, the heating block 44, and the optical fiber connector 46. The heating unit 4B of Modification Example 2 is different from the heating unit 4A of Modification Example 1 in the position of the optical fiber 41 with respect to the heating block 44. Specifically, the light-emitting end 412 of the heating unit 4A of Modification Example 1 protrudes from the outer holder tube tip surface 431b. The optical fiber 41 protrudes from the optical fiber holder 43. Therefore, in Modification Example 1, the light-emitting end 412 of the optical fiber 41 is inserted into the heating block 44. The light-emitting end 412 of the heating unit 4B of Modification Example 2 does not protrude from the outer holder tube tip surface 431b. The optical fiber 41 does not protrude from the optical fiber holder 43. Therefore, in Modification Example 2, the light-emitting end 412 of the optical fiber 41 is disposed inside a through-hole surrounded by the outer holder tube inner peripheral surface 431a.

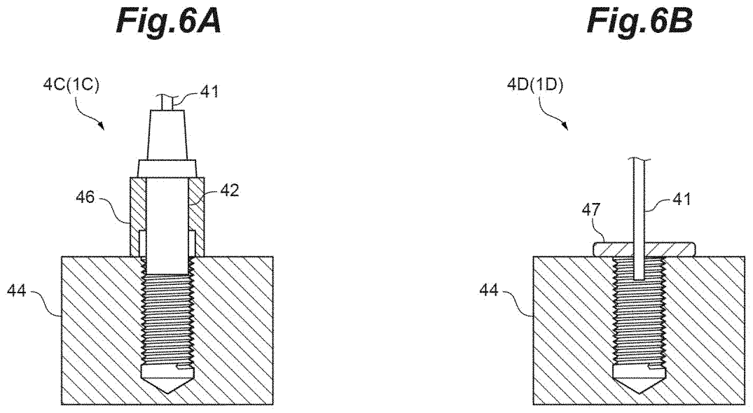

FIG. 6A shows a heating unit 4C included in a refrigeration system 1C of Modification Example 3. The heating unit 4C includes the optical fiber connector 46 and the heating block 44. The heating unit 4C of Modification Example 3 is different from the heating unit 4 of the embodiment in that the heating unit 4C includes the optical fiber connector 46. Further, the heating unit 4C of Modification Example 3 is different from the heating unit 4 of the embodiment in that the heating unit 4C does not include the optical fiber holder 43. The optical fiber connector 46 holding the optical fiber 41 in Modification Example 3 is directly fixed to the heating block 44. A configuration for fixing the optical fiber connector 46 to the heating block 44 is not particularly limited.

FIG. 6B shows a heating unit 4D included in a refrigeration system 1D of Modification Example 4. The heating unit 4D includes the heating block 44. The heating unit 4D of Modification Example 4 is different from the heating unit 4 of the embodiment in that the heating unit 4D does not include the optical fiber holder 43. Further, the heating unit 4D of Modification Example 4 also does not include the optical fiber connector 46. The optical fiber 41 of the heating unit 4D of Modification Example 4 is directly fixed to the heating block 44. For example, the optical fiber 41 may be held by a lid member 47 made of resin.

In the description of the embodiment, the object 91 has been described as being disposed in a place where the object 91 cannot be seen from the heating unit 4. According to such disposition, even if the light L leaks from the heating unit 4, adverse effects due to the leaked light being incident on the object 91 that is, for example, an optical sensor can be suppressed. For example, even when the light L leaks from the heating unit 4, the sensitivity of the optical sensor can be prevented from decreasing. Modification Examples 5 to 10 illustrate several configurations in which the object 91 is disposed in a place where the object 91 cannot be seen from the heating unit 4.

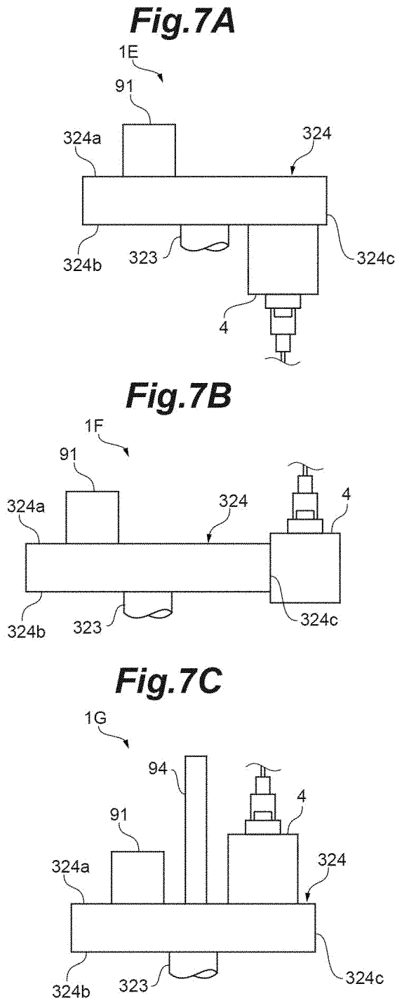

FIG. 7A shows disposition of the object 91 and the heating unit 4 included in a refrigeration system 1E of Modification Example 5. As shown in FIG. 7A, the object 91 is disposed on the upper surface 324a of the second cooling stage 324. The heating unit 4 is disposed on a lower surface 324b (back surface) of the second cooling stage 324.

FIG. 7B shows disposition of the object 91 and the heating unit 4 included in a refrigeration system 1F of Modification Example 6. As shown in FIG. 7B, the object 91 is disposed on the upper surface 324a of the second cooling stage 324. The heating unit 4 is disposed on an outer peripheral surface 324c of the second cooling stage 324.

FIG. 7C shows disposition of the object 91 and the heating unit 4 included in a refrigeration system 1G of Modification Example 7. As shown in FIG. 7C, the object 91 is disposed on the upper surface 324a of the second cooling stage 324. The heating unit 4 is also disposed on the upper surface 324a of the second cooling stage 324. Further, a partition 94 that partitions the object 91 off from the heating unit 4 is provided between the object 91 and the heating unit 4.

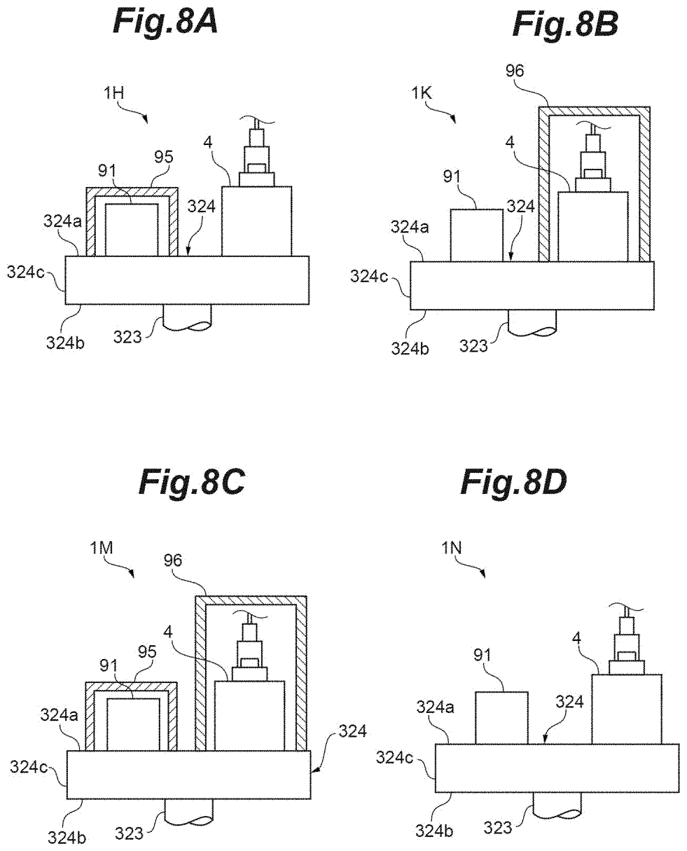

FIG. 8A shows disposition of the object 91 and the heating unit 4 included in a refrigeration system 1H of Modification Example 8. As shown in FIG. 8A, the object 91 is disposed on the upper surface 324a of the second cooling stage 324. The heating unit 4 is also disposed on the upper surface 324a of the second cooling stage 324. An object casing 95 that accommodates the object 91 is disposed on the upper surface 324a of the second cooling stage 324. A casing that accommodates the heating unit 4 is not disposed.

FIG. 8B shows disposition of the object 91 and the heating unit 4 included in a refrigeration system 1K of Modification Example 9. As shown in FIG. 8B, the object 91 is disposed on the upper surface 324a of the second cooling stage 324. The heating unit 4 is also disposed on the upper surface 324a of the second cooling stage 324. A unit casing 96 that accommodates the heating unit 4 is disposed on the upper surface 324a of the second cooling stage 324. A casing that accommodates the object 91 is not disposed.

FIG. 8C shows disposition of the object 91 and the heating unit 4 included in a refrigeration system 1M of Modification Example 10. As shown in FIG. 8C, the object 91 is disposed on the upper surface 324a of the second cooling stage 324. The heating unit 4 is also disposed on the upper surface 324a of the second cooling stage 324. The unit casing 96 that accommodates the heating unit 4 is disposed on the upper surface 324a of the second cooling stage 324. The object casing 95 that accommodates the object 91 is also disposed on the upper surface 324a of the second cooling stage 324.

### MODIFICATION EXAMPLE 11

FIG. 8D shows the object 91 and the heating unit 4 disposed in a refrigeration system 1N of Modification Example 11. As shown in FIG. 8D, it is also possible not to employ the configuration in which the object 91 is disposed in a place where the object 91 cannot be seen from the heating unit 4. The object 91 is disposed on the upper surface 324a of the second cooling stage 324 and the heating unit 4 is disposed thereon. Any member that partitions the object 91 and the heating unit 4 off from each other is not disposed between the object 91 and the heating unit 4. Such disposition refers to that “the object 91 is disposed in a place where the object 91 cannot be seen from the heating unit 4”.

### MODIFICATION EXAMPLE 12

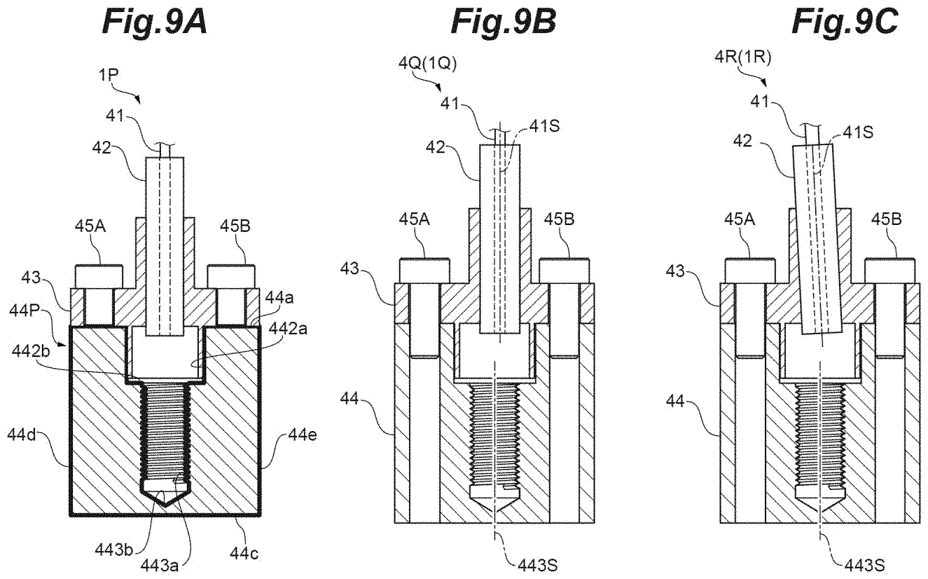

FIG. 9A shows a heating block 44P included in a refrigeration system 1P of Modification Example 12. In the heating unit 4 of the embodiment, processing for enhancing the absorption of light is applied to the inner peripheral surface and the like surrounding the closed region S2. Namely, the block main surface 44a, the block heat-outputting surface 44b, the block bottom surface 44c, the block back surface 44f, and the block side surfaces 44d and 44e of the heating block 44 are not provided with a surface treatment layer such as black alumite. As shown in FIG. 9A, a surface treatment layer of the heating block 44P of Modification Example 12 is not provided on the block main surface 44a, the block heat-outputting surface 44b, the block bottom surface 44c, the block back surface 44f, and the block side surfaces 44d and 44e of the heating block 44. In FIG. 9A, an illustration of some components of the heating block 44P is omitted.

The optical axis 41S of the optical fiber 41 included in the heating unit 4 of the embodiment overlaps the axis 443 S of the light absorption hole 443 (light absorption region S21). In other words, the optical axis 41S of the optical fiber 41 overlaps the axis of the light absorption region S21. The relationship between these axes is not limited to overlapping. FIG. 9B shows a heating unit 4Q included in a refrigeration system 1Q of Modification Example 13. As shown in FIG. 9B, the optical axis 41S of the optical fiber 41 of Modification Example 13 is parallel to the axis 443S of the light absorption hole 443 (light absorption region S21). In other words, the optical axis 41S of the optical fiber 41 is parallel to the axis of the light absorption region S21. However, the optical axis 41S of the optical fiber 41 does not overlap the axis 443 S of the light absorption hole 443. In other words, the optical axis 41S of the optical fiber 41 does not overlap the axis of the light absorption region S21. FIG. 9C shows a heating unit 4R included in a refrigeration system 1R of Modification Example 14. As shown in FIG. 9C, in Modification Example 14, the optical axis 41S of the optical fiber 41 is inclined with respect to the axis 443 S of the light absorption hole 443 (light absorption region S21). In other words, the optical axis 41S of the optical fiber 41 is inclined with respect to the axis of the light absorption region S21.

### OTHER MODIFICATION EXAMPLES

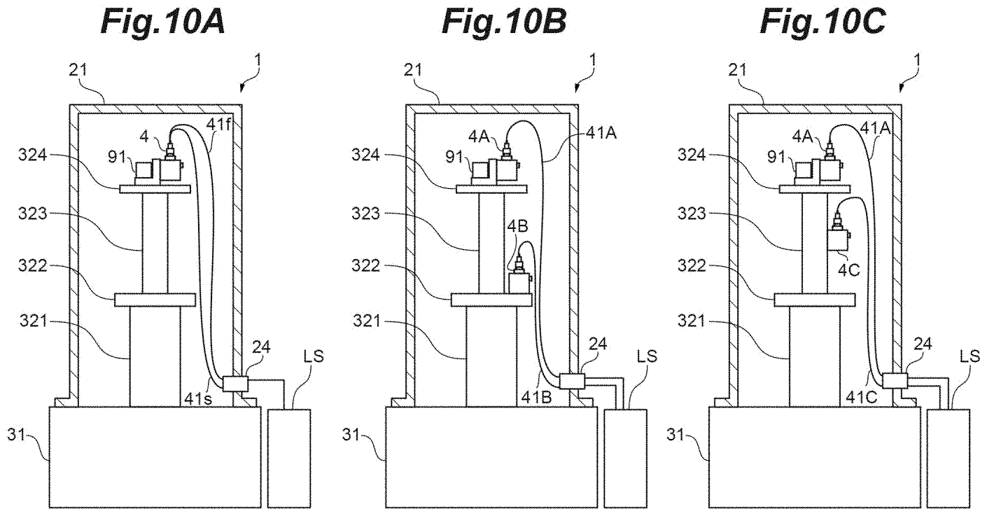

In the embodiment, the number of the optical fibers 41 that guides light to the heating unit 4 is 1. As shown in FIG. 10A, two optical fibers 41f and 41s may be connected to the heating unit 4.

Further, the number of the optical fibers 41 that guides light to the heating unit 4 may be more than 2.

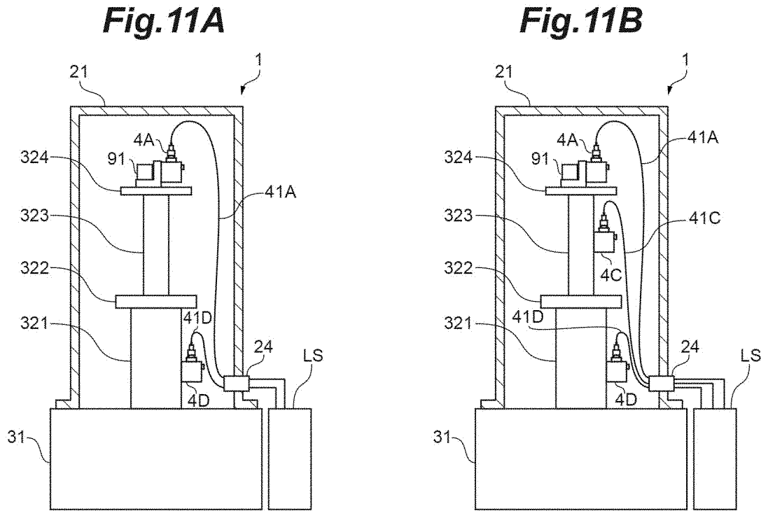

In the embodiment, only the heating unit 4 is attached to the second cooling stage 324. The number of the heating units 4 included in the refrigeration system 1 may be a plural number. For example, as shown in FIG. 10B, the refrigeration system 1 may further include the heating unit 4B attached to the first cooling stage 322, in addition to the heating unit 4A attached to the second cooling stage 324. The heating unit 4A includes an optical fiber 41A. The heating unit 4B includes an optical fiber 41B. As shown in FIG. 10C, the refrigeration system 1 may further include the heating unit 4C attached to the second column 323, in addition to the heating unit 4A attached to the second cooling stage 324. The heating unit 4C includes an optical fiber 41C. As shown in FIG. 11A, the refrigeration system 1 may further include the heating unit 4D attached to the first column 321, in addition to the heating unit 4A attached to the second cooling stage 324. The heating unit 4D includes an optical fiber 41D. As shown in FIG. 11B, the refrigeration system 1 may include the heating unit 4C attached to the second column 323 and the heating unit 4D attached to the first column 321, in addition to the heating unit 4A attached to the second cooling stage 324.

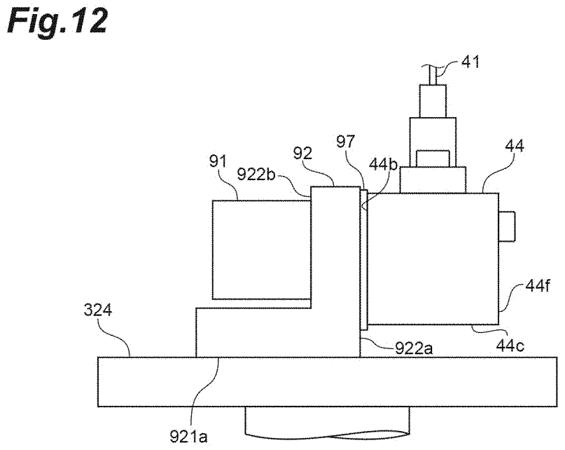

In the embodiment, the heating block 44 is brought into direct contact with the holding member 92. As shown in FIG. 12, the heating block 44 may be fixed to the holding member 92 with a member sandwiched therebetween. For example, the heating block 44 and the holding member 92 may be connected to each other with a heat conductive member 97 made of relatively soft metal (indium or the like). As a result, a contact area of the heat conductive member 97 with respect to the heating block 44 is increased. Further, a contact area of the holding member 92 with respect to the heat conductive member 97 is increased. Namely, thermal resistance from the heating block 44 to the holding member 92 decreases due to an increase in contact area. As a result, heat can be satisfactorily transferred from the heating block 44 to the holding member 92.

### EXPERIMENTAL EXAMPLE 1

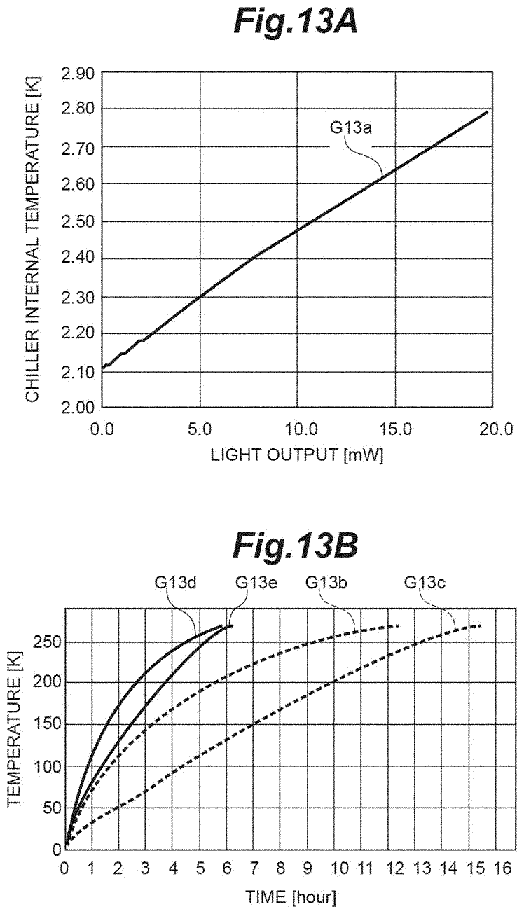

In Experimental Example 1, a heating capacity of the heating unit 4 was evaluated. Specifically, in Experimental Example 1, it was confirmed that the temperature of an object could be increased by operation of the heating unit 4. The graph of FIG. 13A shows a relationship between light output and internal temperature. The horizontal axis shows an output of light provided for heating. The horizontal axis shows light output of light with which the heating unit 4 is irradiated. The vertical axis shows internal temperature of the vacuum chamber 2 at the time temperature equilibrium is reached after the start of light irradiation at each light output. In Experimental Example 1, the internal temperature is temperature of the second cooling stage 324. The heating unit 4 was attached to the second cooling stage 324. The object of Experimental Example 1 was the second cooling stage 324. Referring to a graph G13a, it was confirmed that the internal temperature also increased with an increase in light output. When energy of input light increased, thermal energy generated by the heating unit 4 also increased. It was found that the temperature of the second cooling stage 324 that was an object also increased with an increase in thermal energy. It was found that the relationship between the light output and the internal temperature was an approximately proportional relationship.

In the refrigeration system 1 including the heating unit 4 having such a characteristic, a cooling capacity of the chiller 31 can also be evaluated. A heat quantity supplied to the inside of the vacuum chamber 2 can be controlled by controlling the output of laser light. In a state where a predetermined heat quantity per unit time is supplied to the inside of the vacuum chamber 2, the setting is such that a heat quantity equal to the heat quantity supplied to the chiller 31 is removed. When the chiller 31 normally operates, a provided heat quantity and a removed heat quantity are equal. As a result, the temperature of the object disposed inside the vacuum chamber 2 does not change. Conversely, when the chiller 31 does not operate normally, namely, when the cooling function of the chiller 31 is degraded, a provided heat quantity and a removed heat quantity are not in balance. As a result, the temperature of the object disposed inside the vacuum chamber 2 rises. An inspection as to whether or not the chiller 31 operates normally can also be performed through such a test.

### EXPERIMENTAL EXAMPLES 2 and 3

In Experimental Examples 2 and 3, the time from when the operation of the chiller 31 was stopped to when the temperature rose to a temperature at which the vacuum chamber 2 could be opened was confirmed. Room temperature was set as the temperature at which the vacuum chamber 2 could be opened. In Experimental Example 2, as a comparative example, the condition was that heating by the heating unit 4 was not performed. In Experimental Example 3, as a comparative example, the condition was that heating by the heating unit 4 was performed. FIG. 13B shows a change in internal temperature over time. The horizontal axis shows elapsed time from the timing when the operation of the chiller 31 is stopped. The vertical axis shows internal temperature. In Experimental Examples 2 and 3, objects were the first cooling stage 322 and the second cooling stage 324. In Experimental Example 3, the heating unit 4 was attached to the first cooling stage 322, and the heating unit 4 was also attached to the second cooling stage 324. A maximum output of light provided to the heating unit 4 was 9 W in all cases.

Graphs G13b and G13c of FIG. 13B show results of Experimental Example 2. The graph G13b shows temperature of the first cooling stage 322. According to the graph G13b, the time taken for the temperature of the first cooling stage 322 to rise to room temperature was approximately 12 hours. The graph G13c shows temperature of the second cooling stage 324. According to the graph G13c, the time taken for the temperature of the second cooling stage 324 to rise to room temperature was approximately 15 hours. When the heating unit 4 was not used, it was found that the vacuum chamber 2 could not be opened for approximately 15 hours from when the operation of the chiller 31 was stopped.

Graphs G13d and G13e of FIG. 13B show results of Experimental Example 3. The graph G13d shows temperature of the first cooling stage 322. According to the graph G13d, the time taken for the temperature of the first cooling stage 322 to rise to room temperature was approximately six hours. When the heating unit 4 was not used, the time taken for the temperature of the first cooling stage 322 to rise to room temperature was approximately 12 hours. Therefore, it was found that the time taken for the temperature of the first cooling stage 322 to rise to room temperature could be shortened by approximately six hours by using the heating unit 4. The graph G13e shows temperature of the second cooling stage 324. According to the graph G13e, the time taken for the temperature of the second cooling stage 324 to rise to room temperature was also approximately six hours. When the heating unit 4 was not used, the time taken for the temperature of the second cooling stage 324 to rise to room temperature was approximately 15 hours. Therefore, it was found that the time taken for the temperature of the second cooling stage 324 to rise to room temperature could be shortened by approximately nine hours by using the heating unit 4. When the heating unit 4 was used, it was found that the vacuum chamber 2 could be opened when approximately six hours elapsed from when the operation of the chiller 31 was stopped. It was found that compared to when the heating unit 4 was not used, the standby time from when the chiller 31 was stopped could be shortened by approximately nine hours.

What is claimed is:

1. A refrigeration system comprising:
a chamber forming a cooling region which accommodates an object and in which cooling is performed;
a cooling unit that cools the object accommodated in the cooling region; and
a heating unit disposed in the cooling region to generate heat,
wherein the heating unit includes a heating block that is disposed in the cooling region and that receives light to generate heat, and a light irradiation unit that irradiates the heating block with the light,
the heating block includes a closed region isolated from the cooling region, and
the light irradiation unit irradiates the closed region with the light.

2. The refrigeration system according to claim 1,
wherein the closed region is isolated from the cooling region by a lid unit fixed to the heating block, and
the lid unit includes the light irradiation unit.

3. The refrigeration system according to claim 1,
wherein the closed region includes a light absorption region to be irradiated with the light, and
the light absorption region has a light absorption surface having a higher absorptance for the light than an absorptance of a base material of the heating block.

4. The refrigeration system according to claim 3,
wherein the light absorption region has a tubular shape, and
the light absorption surface is an inner peripheral wall surface surrounding the light absorption region.

5. The refrigeration system according to claim 4,
wherein the light absorption surface has an undulating shape.

6. The refrigeration system according to claim 3,
wherein a bottom of the light absorption region is defined by a light absorption hole bottom surface, and
the light absorption hole bottom surface has a tapered shape.

7. The refrigeration system according to claim 3,
wherein the closed region includes a light-emitting end exposure region where a light-emitting end of the light irradiation unit is disposed, and
an area of a cross section of the light-emitting end exposure region intersecting an optical axis of the light irradiation unit is larger than an area of a cross section intersecting an optical axis of the light absorption region.

8. The refrigeration system according to claim 1,
wherein the light irradiation unit further includes an optical fiber that guides the light, and an optical fiber holder holding the optical fiber and attaching the optical fiber to the heating block.

9. The refrigeration system according to claim 8,
wherein a thermal conductivity of a base material of the heating block is larger than a thermal conductivity of a base material of the optical fiber holder.

10. The refrigeration system according to claim 1,
wherein the heating block has a first main surface and a second main surface intersecting the first main surface,
the light irradiation unit is disposed on the first main surface, and
the second main surface thermally contacts the object.

11. The refrigeration system according to claim 10,
wherein a heat conductive member is sandwiched between the second main surface and the object.

12. The refrigeration system according to claim 1,
wherein the cooling unit includes a chiller and a support table that is connected to the chiller and that is disposed in the cooling region,
the support table includes a stage on which the object is disposed, and a column that supports the stage, and
the heating unit is attached to the column.

13. The refrigeration system according to claim 1,
wherein the cooling unit includes a chiller and a support table that is connected to the chiller and that is disposed in the cooling region,
the support table includes a stage on which the object is disposed, and a column that supports the stage, and
the heating unit is attached to the stage.

14. The refrigeration system according to claim 1,
wherein the object includes an optical sensor that outputs a signal in response to incident light.
